(19) United States
(12) Patent Application Publication
(10) Pub. No.: US 2009/0271312 A1
(43) Pub. Date: Oct. 29, 2009

(54) One-Price Home Mortgage Lending Method and System

(76) Inventor: Yung-Sung Chien, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/495,923

(22) Filed: Jul. 1, 2009

Related U.S. Application Data
(63) Continuation-in-part of application No. 12/032,932, filed on Feb. 18, 2008.

(30) Foreign Application Priority Data
May 11, 2007 (TW) 096116746
Nov. 14, 2007 (TW) 096142987

(51) Int. Cl. G06Q 40/00

(52) U.S. Cl. 705/37

(57) ABSTRACT

A method and system for an online one-price home mortgage lending is disclosed. House buyers use the system to obtain a mortgage with autonomous interest rates. The system provides a loan to members to allow them to get their house in advance or to pay off an existing home mortgage. After receiving the loan members participate in an auction process. The bid-winner receives the funds and repays the loan in installments. Non bid-winners are issued a transferable auction certificate and wait until the next term to bid again.

### BACKGROUND OF THE INVENTION

1. Field of the Invention

The present invention relates to financial systems. More specifically, the present invention discloses a method and system for providing online one-price home mortgage loans using an auction.

2. Description of the Related Art

Home loans are typically acquired from traditional banking institutions and are one of a bank's core businesses. However, financial institutions must perform asset/liability management by trying to match the maturity of their deposits with the length of their loan commitments. This is done to avoid being adversely affected by changes in interest rates. Banks make loans at interest rates that differ from interest rates paid on deposits. For example, a typical mortgage loan is repaid over 20 years compared with a term deposit of 1 to 3 years. Since deposits usually have shorter maturity than loans there is often a mismatch between assets (loans) and liabilities (deposits). This is called the asset/liability gap.

Banks are subject to short-run variations on short-term deposits and are expected to earn profits through long-term mortgage loans. They provide floating rate loans to shift the interest rate risk to mortgage clients. Because of this mortgage clients are not able to estimate the total interest payments.

To solve this problem many insightful bankers are looking for creative ways to remedy the current situation. “Interactive mortgage and loan information and real-time trading system”—U.S. Pat. No. 5,995,947 provides a method for lenders to place an offer and asks borrowers to choose the right lender. Loan providers could be individuals or financial institutions. However, since the loan period is long it is very difficult for an individual to act as a loan provider due to the lack of liquidity. Also, if the funds provider is a financial institution the interest rate differential still exists.

“System and method for implementing a mortgage plan”—U.S. Pat. No. 6,904,414 provides an accelerated principal amortization mechanism in which lenders may share the benefit from the possible increase in future house prices. The lenders expect the price of housing will increase. The patent considers folding the rising house prices into the mortgage. Typically, this is good for borrowers since they can get a cheaper loan. However, this method is not advantageous for lenders since they still bear higher interest-rate risk while house prices keep falling and interest rates rise.

Therefore there is need for a more effective method of providing lending and borrowing opportunities for fixed rate loans.

### SUMMARY OF THE INVENTION

To achieve these and other advantages and in order to overcome the disadvantages of the conventional method in accordance with the purpose of the invention as embodied and broadly described herein, the present invention provides a method for a one-price home mortgage lending system.

The present invention responds to a direct Internet-based lending mechanism using Internet technology. In the method and system there is no substantial distance and friction between the mortgage clients and the deposit clients. The lending funds, which are determined by auction, can be directly supplied by house buyers in order to respond to the intensity of individual demand under the mechanism of combining depositing and lending operations.

In order to achieve said purpose the present invention provides Internet technologies and a data processing facility. Members employ wired or wireless devices such as a computer, a PDA, a notebook computer, or a mobile phone to connect to the system server and initiate the auction and capital appropriation process. Via the database the system analyzes supply and demand of capital market funding, set a reasonable interest rate, carry out a house appraisal, analyze a loan amount, calculate cash flow of auction funds in the system, and prepare an auction certificate.

The method for the one-price home mortgage lending system of the present invention provides for a direct online encounter opportunity between mortgagers and depositors. The lending funds can be directly supplied by the house buyers. Banks in its role are not only fiscal agents for earning the interest rate differential, but also are new agents for providing the financial system to charge a handling fee and a guarantee fee. Banks without funds-pressure can manage the mortgage and help customers achieve their long-term financial benefit with one-price mortgage lending. This solves the plight of their business operations, which employ an Asset/Liability Gap.

The method and system of the present invention applies a concept of direct finance to include a form of funding bargain system into the mortgage business. One of the characteristics of the system is, via the mechanism of combining savings and lending operations, to make consumers combine banking funds and personal savings for purchasing a house. Therefore, this system can assist banks to solve the plight of business operations with the short-term deposit assistance to long-term loans.

Another characteristic of the system is the relationship between members and system providers. Lending system providers provide a one-to-one auction to members, so the offers can go back and forth until both parties have agreed. Therefore, this system provides an affordable loan to members, and it is a custom-based loan product based on members' economic ability.

Another characteristic of the system is that the bid-winner will pay a fixed amount each term for the rest of the period. This system provides members with home loan products without interest rate risk. It can better protect consumers while the long-term home loan markets still carry variable interest rates.

Since the system utilizes Internet technologies to meet the needs of both lenders and borrowers, transaction costs are reduced and both sides benefit. Therefore, this system not only provides more favorable interest rates to mortgage members, but also provides superior interest rates for term deposits exclusive to deposit members.

The method of the present invention provides an exit mechanism for system participants. Members according to their personal requirements can transfer their auction certificates, thus they can use funds in more flexible way.

Currently, home loans provided by banks have a high level of homogeneity, and most do not satisfy customer demand. Due to banks applying short-term liquidity assistance to long-term loans, interest rate change is unpredictable and most home loan products today offer floating rate loan and then enhance the default risk. Therefore, uncertainty of repayment may arise. In fact, when interest rates increase substantially, it presents bankruptcy risk to banks. The method and system of the present invention not only changes the phenomenon of short-term cash inflow (deposits) to long-term cash outflow (loans) and the earning of interest-rate differential, but also provides a custom-based product with one-price repayment plan. Both the borrower and depositor sides can receive a loan that is superior to current market conditions. There is an obvious different market segment and superiority when comparing the present invention with other loan products.

An objective of the present invention is to combine the home loan and the direct financial system. Members, according to their house-purchasing plan, choose to deposit on the system or apply directly for a home loan. Borrowers who already have mortgages can refinance their homes using this system. After a member enters into the system to place bids, the bid-winner will pay a fixed amount each term which prevents interest rate risk.

Another objective of the present invention is to employ a method of combining savings and lending operations in order to collect funds. Both banks and clients can undertake lending funds together. The risk of capital cost which is undertaken by banks and clients can be reduced, and the plight of the Asset/Liability Gap can be gradually solved. The interest-rate differentials are replaced by commission fees.

Another objective of the present invention is to provide a funding system with integrated savings and borrowing function for members who are ready to purchase a house. As a tool for accumulating funds for a down payment on a house, it can obtain a favorable interest rate. The system provides procedures including a deposit preparation before purchasing the house and has a future fixed amount payment plan. Therefore, it is a linear-type home loan that is different from a conventional point-type mortgage loan. A linear-type loan comprises multiple deposits prior to the actual loan. For example, a member can make 5 deposits before becoming the bid-winner and receiving the loan. In contrast the conventional loan is considered a point-type loan since the loan is received upon approval of the loan application.

An objective of the present invention is to provide members a custom-based repayment plan. Members can continue to offer a bid until they obtain a better interest rate than other home loans.

This home loan product includes an integrated deposit and lending mechanism. Banks not only can attract loan clients, but also can attract clients who are depositors. This increases client loyalty and increases bank business.

The mortgage lending method and system has a function integrating saving and lending. It not only provides lending funds to clients, but also provides better financial and management services to clients. This increases the opportunity for selling other financial products. For example, in addition to a home mortgage loan the system operator can offer other financial products such as insurance, funds, etc. to members.

The present invention employs a securitization function. The system issues an auction certificate according to a member's own auction privilege. A member can also transfer their auction certificates and opt to begin early exit transactions according to their needs and the variation in an anticipated capital. The flexible use of funds increases the willingness to participate in system transactions.

In order to achieve the abovementioned objects, the present invention provides a one-price mortgage lending system. The system comprises a server that couples to users via the Internet or a private network. Users connect to the server which provides a dedicated webpage.

A membership auditing and login process is provided. A user becomes a member by inputting all basic information, applying for an application audit, and receiving membership approval. The member enters the system web server, logs into his/her account and types his/her password. The system proceeds with the authentication and completes the login procedure.

A mortgage lending application process is also provided. Members choose to directly deposit funds or apply for a home loan. If a member chooses to directly deposit funds they become a deposit member. If they choose to apply for a home loan they become a home loan member. A home loan member applies for an appraisal first, and then organizes the home loan structure. If the member does not agree to the structure, then he/she becomes a deposit member. If the member agrees to said structure, then he/she signs the contract and creates a mortgage to his/her house. After the process has been completed, the member receives the loan. The lending system directly remits funds to the seller or to the original institution.

The present invention further provides an auction process. According to the loan amount and loan term, the member can either make an offer in a built-in system, or choose not to make an offer and become a depositor. The member who wants to make an offer inputs a bid price. If the system accepts the offer, then the member who wins the bid becomes a borrower. If the system does not accept the offer, the member can decide whether or not to continue to make an offer. If the member decides not to make an offer, then the bidding transaction is closed and the member becomes a depositor. If the member decides to make an offer again, they reset the bid price.

A clearing and delivering process is also provided. A depositor via the system clears his due payments and makes his payment payable to the system in order to complete the transaction. A borrower via the system clears his/her receivable and the system remits its receivable to the borrower for completing the transaction.

The present invention also provides an operation process for auction certificates of a home loan. After a deposit member has remitted payment into the system and completes his transaction, the system calculates total payment and issues an auction certificate to the member. The member decides whether or not to trade his/her auction certificate. If the answer is no, the system will deposit the member's auction certificate into a custody institution. If the answer is yes, the member performs a transfer transaction for the auction certificate on the system.

The one-price home mortgage lending system of the present invention comprises a server. Members can employ Internet technologies, a wire/wireless communication device, or local area networks to link to the user interface of the server. Members exchange information securely with the server in real time. Members perform their identification audit, home loan application, auction trading, and clearing and transaction delivering by interacting with the server. The system also stores the abovementioned data into the database, and records results and updates data.

The server employs a member identification auditing module to process applicant's personal information in order to determine an applicant's eligibility. This data is stored in a database and retrieved to verify a member's login information.

The server also employs a house appraisal module to process a member's basic house information and appraisal results. This information is stored in the database. The loan amount auditing module or the loan structure organization module can retrieve said information to use as the basis for calculations.

A loan amount auditing module is provided to allow the server to estimate the loan amount which is then stored in the database files.

The server employs a home loan structure organization module to analyze the composition structure of total loan amount. This structure means a mortgage loan, a credit loan and the minimum allowable ratio of down payment to sale price. This information is stored in the database.

The server employs a home loan auction transaction module to process a member's auction fund, and operates with the interest rate calculation module to decide whether to accept a member's offer until the member wins the bid or exits the trading.

According to current market interest rates and auction fund interest rates and fund level, the server employs an interest rate calculation module to estimate the current possible number of the bid-winner and the interest rate of the auction fund, and stores the information into the database.

The server employs a clearing and delivering module to carry out clearing and delivering for the bid-winner and the non bid-winners, and stores the information into the database.

A home loan auction certificate module stores the auction certification of the home loan which is approved by the server, and stores data and the results of the auction certificate.

Another advantage of the present invention is that a member can obtain a preliminary loan prior to winning the bid. For example, a member participates by depositing for a number of terms. When the member has enough money for a down payment on a house he/she participates in the auction process. However, the member is not successful and doesn't become the bid-winner for several auctions. Unfortunately, the house the member wants to buy may be sold to another person by the time the member wins the bid. In order to prevent this situation the method of the present invention allows the member to obtain a preliminary loan in order to make the down payment. When the member becomes the bid-winner the member repays this preliminary loan.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a flowchart illustrating a one-price mortgage loan method according to an embodiment of the present invention;

FIG. 2 is a flowchart illustrating an early-stage lending process according to an embodiment of the present invention;

FIG. 3 is a flowchart illustrating implementation of the system mortgage lending transaction according to an embodiment of the present invention; and

FIG. 4 is a diagram illustrating a one-price mortgage lending system according to an embodiment of the present invention.

### DETAILED DESCRIPTION OF THE PREFERRED EMBODIMENT

Reference will now be made in detail to the preferred embodiments of the present invention, examples of which are illustrated in the accompanying drawings. Wherever possible, the same reference numbers are used in the drawings and the description to refer to the same or like parts.

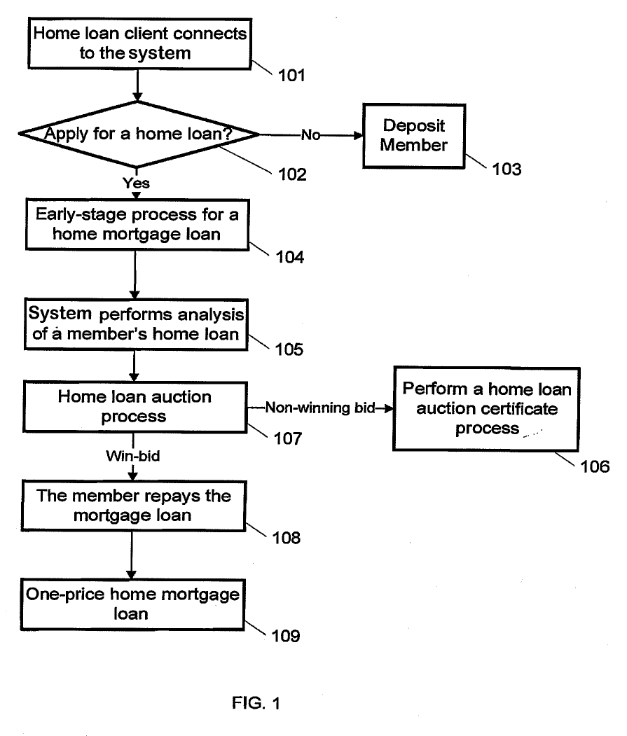

Refer to FIG. 1, which is a flowchart illustrating a one-price mortgage loan method and system according to an embodiment of the present invention. In the method a mortgage client enters into the one-price mortgage lending system in Step 101. The mortgage clients include those who wish to buy a house, those who are ready to refinance their mortgage, and those who are ready to buy a house. In Step 102 members choose whether or not they want to apply for a mortgage loan. If the member temporarily has no demand for a mortgage, they become a direct deposit member in Step 103 without applying for the mortgage. If the member has a demand for a mortgage, they enter the system for an early-stage lending process in Step 104. If the deposit member has a mortgage demand in the future, they can enter into the early-stage lending process to apply for the mortgage. After the early-stage lending operation has finished the loan amount structure module of the system will process and analyze the mortgage loan, the credit loan and the down payment in order to select the most suitable mortgage program for the member in Step 105. In Step 107 the member initiates a bid on the lending system. The member can submit a bid price for a current term until the time period to place bids has expired. If the member does not win the bid they will continue to submit bids with escalating bid prices for other opportunities with deposit membership status in Step 106. According to the payable amount after the transaction the system further calculates, audits, approves and then issues the auction certificate. The member can decide whether to perform the auction certificate transaction. If the member wins the bid, they repay the mortgage loan with the winning bid funds in Step 108, and this fund is used as a member's new loan. As a result, a new home loan is a fixed payment loan and is a one-price mortgage in Step 109. Therefore, the member can eliminate the risk of fluctuating interest rates.

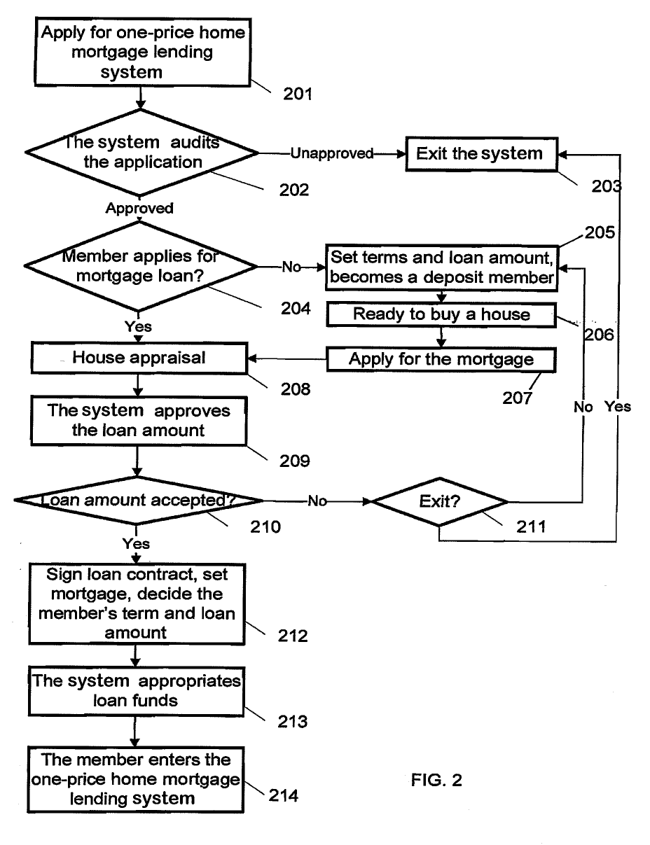

Refer to FIG. 2, which is a flowchart illustrating an early-stage lending process according to an embodiment of the present invention. After the client has applied for a loan using the one-price mortgage lending system in Step 201, the system audits the application by reviewing the basic information of the member in Step 202. If the client cannot pass the review, they are not allowed onto the system and they exit in Step 203. If the member passes the auditing, they then decide whether or not to apply for a mortgage loan in Step 204. If the member decides to continue the loan application process, they ask the house appraisal module to perform a house appraisal for a target house in Step 208. The mortgage lending module calculates the loan amount from the appraisal report, and the system approves a loan based on this loan amount in Step 209. The member according to the loan amount decides whether to receive the approval in Step 210. If the answer is yes, the member signs a mortgage contract with the system and has their house mortgaged in Step 212. The system or both sides coordinate the mortgage terms and loan amount. After the contract has been determined, the system immediately approves and appropriates the funds in Step 213. The loan funds are either remitted directly to the seller from the system or from the original loan institution. The member then can enter into the one-price home mortgage lending system in Step 214.

As described above, if the member decides not to apply for the mortgage loan in Step 204, the system or both sides coordinate to decide the terms and funds amount for participating in the system and the member becomes the deposit member in Step 205. In Step 206 when the member has a demand for a mortgage they apply for a mortgage using the system in Step 207. In step 208, the member and system then do the steps of house appraisal, signing the contract, mortgaging the member's house. The deposit member then becomes an authorized home loan member.

As shown in FIG. 2, the member can choose whether to accept the approval loan amount in Step 210. If the member chooses to not accept, the member can decide whether to exit the system in Step 211. If the member exits the system, then they quit the application in Step 203. If the member does not exit the system they become a deposit member and return to Step 205. The system or both sides coordinate to decide the terms and funds amount for participating in the system.

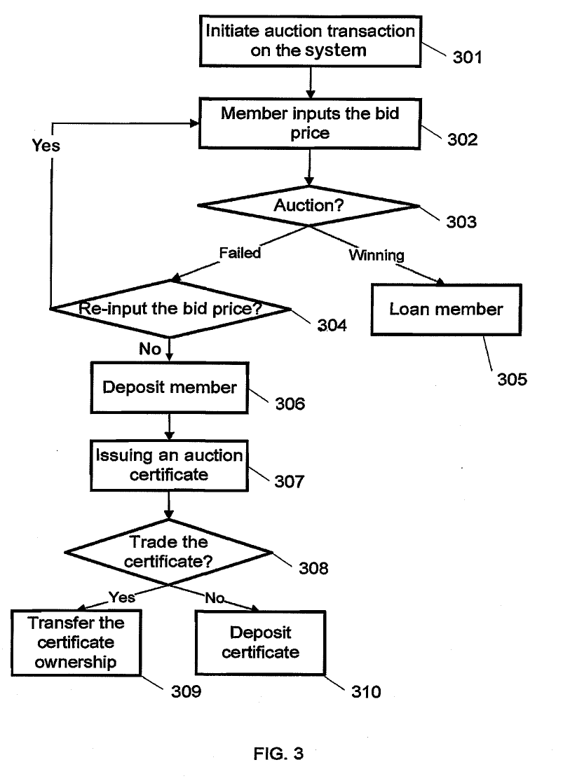

Refer to FIG. 3, which is a flowchart illustrating implementation of the system mortgage lending transaction according to an embodiment of the present invention. The member who has the auction privilege (the member who has signed the contract and has had their house mortgaged) decides whether or not to submit a bid request. If the member decides to submit the bid in Step 301, they input a bid price in Step 302. The system according to the input data performs an auction process in Step 303. The bidding price determines the member's lending rate. That is to say the server can select the assessment standard according to the supply and demand of funds, the level of funds of the system, and the long-short-term interest rate differentials.

If the member wins the bid, the member accepts the bid price as the lending rate and become a loan member in Step 305. The member repays the loan by using the auction funds. This one-price lending feature makes new loans and prevents interest-rate risk. If the member did not win the bid, they can decide whether or not to re-input a bid in Step 304. If the member decides to re-input the bid, then the system returns to the input bid field in Step 302. If not, then the member remains in deposit member status in Step 306. According to the payable amount of the deposit member, the system further calculates, audits, approves and issues the auction certificate in Step 307. The member decides whether or not to perform the auction certificate transaction in Step 308. If the member decides to perform an auction certification transaction on the system, the member then performs the transferring process for the auction certificate in Step 309. If the member does not perform the auction transaction, then they become a deposit member and own an auction certificate in Step 310.

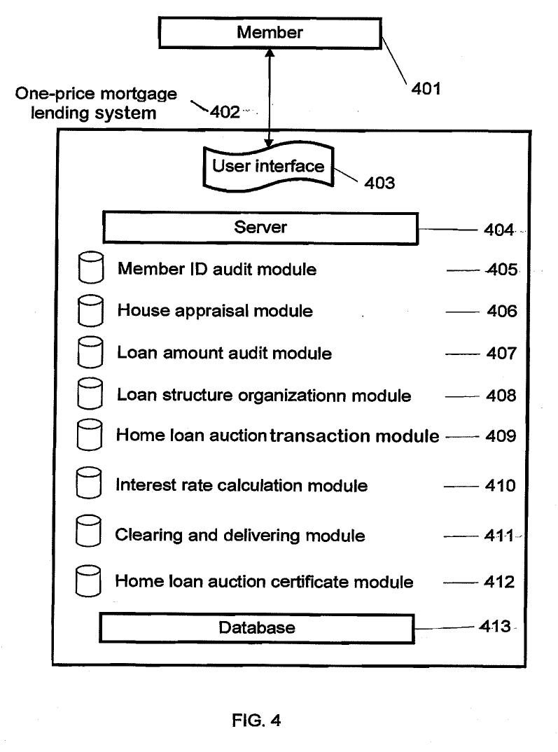

Refer to FIG. 4, which is a diagram illustrating a one-price mortgage lending system according to an embodiment of the present invention. The system 402 comprises a server 404, which employs Internet technologies, a wire/wireless communication device, a private or local area network to provide a user interface 403 of the server to the member 401. The server also allows clients with a computer, a mobile phone, or a PDA to link to the system 402 via the network. The server 404 exchanges information securely in real time with members 401, with a links database 412, and with each module for storing data, information and results into the database 413.

The one-price mortgage lending system 402 further comprises the following modules:

Member identification auditing module 405 for storing a user's personal information in order to verify the user: The member identification auditing module 405 has basic information of the clients or users. It determines whether or not to accept the application. Via the server 404 the member identification auditing module 405 operates, processes, analyzes and executes, and then stores information in the database.

House appraisal module 406 for appraising a house value for a target house regarding to the user to generate an appraisal result: The house appraisal module 406 carries out procedures such as discrimination, analysis, and values determination for the target house. This data is then stored in the database 413.

Loan amount auditing module 407 for retrieving the user's personal information and the appraisal result to determine an auction combination: The loan amount auditing module 407 retrieves analysis data created by the member identification auditing module 405 and the house appraisal module 406 and calculates an auction combination for the target house. This data is then stored in the database 413. The auction combination comprises a loan amount, repayment terms for the loan amount and a unit price for each repayment term; wherein the unit price is set forth by dividing the loan amount to the repayment terms.

Home loan structure organization module 408 for analyzing and comparing difference between the appraisal result and the loan amount: This module 408 helps the member analyze the appraisal report and the loan amount, and it compensates for insufficient funds by using other loans such as, second mortgages and credit loans. In addition, the home loan structure organization module 408 enables the member to know the down payment and total loan amount in order to facilitate decision making about the mortgage.

Home loan auction transaction module 409 for receiving a bid price submitted by the user and deciding whether or not accepting the bid price according to the acceptable bid price level: This module 409 is used to help a member to get the loan amount and perform the auction process. The home loan auction transaction module 409 creates the auction system and makes auction fund analysis and decisions. In one embodiment of the present invention, the home loan auction transaction module 409 sets forth a time period for receiving the bid price from the user, and if the bid price is not accepted, the home loan auction transaction module 409 allows the user to continuously submit an escalating bid price.

Interest rate calculation module 410 for calculating an interest rate for the loan amount to decide an acceptable bid price level: The interest rate calculation module 410 decides whether or not the bid price is reasonable. The module uses the funds' supply and demand, the funds level of the system, and the long-short-term interest-rate variation, etc. to decide the acceptable bid price level. If yes, it notifies the server 404 to accept the bid, if no, then it rejects the bid.

Clearing and delivering module 411 for clearing and delivering the users' payments for each unit price, each repayment price or each unit deposit: The clearing and delivering module 411 clears the bidding result, helps the member to repay the mortgage, and helps members receive the delivering of one-price mortgage lending.

Home loan auction certificate module 412 for issuing an auction certificate: This module is used to store the auction certificate that is approved by the server 404 and to store the data and result of the auction certificate that the member has used or traded. In one embodiment of the present invention, if the bid price submitted by the user is not accepted, the home loan auction certificate module 412 issues a home loan auction certificate to the user for allowing the user to submit another bid price at other repayment terms. In one embodiment of the present invention, the home loan auction certificate is transferable by the home loan auction certificate module 412.

Database 413: The database 413 is provided to store the data for the operation, process, analysis, cross examination, and execution of each module for the server 404. Each module and the server 404 can retrieve data from the database 413 in order to operate, process, analyze, cross examine, and execute the corresponding functions.

By the system 402, if the user does not submit the bid price, the system 402 requests the user to provide the unit price at every repayment term to become a depositor; if the user submits the bid price and the bid price is accepted, the system 402 allows the user to obtain a loan fund and repays an repayment price at every remaining repayment term; and if the bid price is not accepted, the system 402 requests the user to provide a unit deposit to become a depositor. In one embodiment of the present invention, at least one of the amounts of the loan fund, the repayment price and the unit deposit is determined according to the bid price.

In the following three examples, an embodiment of a specific implementation of the method of the present invention is applied.

Implementation 1:

Mr. A is an office worker and is married. Mr. A purchased a house a few years ago. He has applied for a home loan at a bank (Bank A). At present, he has an outstanding balance of a mortgage account of around $600,000 with a 15-year repayment term. Due to the increase in interest rate volatility, he decides to apply for a mortgage with the one-price mortgage lending system in order to reduce the interest rate and avoiding interest-rate variation. First, Mr. A completes the online application procedure and joins the system. After the system has reviewed his loan application data, he starts to prepare the pre-approval process, such as estate appraisal, mortgage, decision for auction, and the approval process. After the appraisal, the current value of the house has been assessed at $675,000. According to data provided to the financial institutions that operate the system, the lender may originate a mortgage loan with a loan-to-value ratio at 80%. Therefore, Mr. A receives a loan of $540,000.

Due to insufficient funds to repay the original amount of the loan, Mr. A needs another $60,000 loan to payoff his $600,000 loan. This loan of $60,000 can be a credit or collateralized loan. After Mr. A has finished the loan application of $60,000, the financial institution provides Mr. A with funds totaling $600,000 ($540,000 of loan funds and additional $60,000) as a preliminary loan so that he can pay off his original loan from Bank A. After the system has received the liquidation certificate from Bank A and Mr. A has his house mortgaged to the system for the preliminary loan, Mr. A obtains the credit to attend the auction for loan funds on the system.

The system, according to the loan amount and the life span of the house, decides Mr. A's attending duration and funds amount. Alternatively, the client can decide whether or not to attend according to the approval loan amount and the repayment terms. Mr. A wishes to have a 15-year loan and minimal interest rate risk in the future. He decides to attend a $540,000 auction combination for a 15-year term (i.e. 180 terms), submitting one bid for each month and the upper limit on the bidding price is set at $3,000 (i.e. 540,000/180=3,000).

After Mr. A has attended the funds auction system, his offer is analyzed by the system interest-rate calculation module and is accepted by the system and the transaction is completed. The funds are obtained using the following to calculate:

The Nth term winning-bid funds

$$\begin{matrix}An = ( U - In ) \times ( ( N - n ) ) + ( U \times ( n - 1 ) ) or & Formula 1 \\ An = ( U \times ( N - n ) ) + ( U \times ( n - 1 ) ) + {\sum }_{i = 1}^{n - 1} Ii & Formula 2\end{matrix}$$

### Wherein

An: Denotes the total amount of the Nth term winning-bid funds

U: Denotes the unit price

N: Denotes the total terms

n: Denotes the current term of bids on the system

In: Denotes the Nth term bidding price

Ii: Denotes the bid price submitted by the user in the prior i-th term

According to Formula 1, Mr. A offers $100 bid in the first term, the system via the analysis of the interest-rate calculation module accepts the offer, and then Mr. A can obtain ($3,000−$100).×.(180−1)+$3,000.×.(1−1)=$519,100

Therefore the auction fund of $519,100 obtained from the auction system is requested to repay the outstanding $540,000 mortgage loan. Since the funds of the mortgage lending system are determined using an auction mechanism, the amount of the auction fund has an uncertainty. The funds obtained from the auction process may not be sufficient to reimburse the total loan amount. Thus, the outstanding loan still has $20,900 left due after the existing loan is paid. Therefore, a short term credit loan is needed in order to fully repay the debt.

After Mr. A receives the winning bid for $519,100 to partially repay his loan, he must repay a repayment price of $3,000 (i.e. the unit price) monthly with the system during the existing period (this case has 179 terms). During the auction process using the system and payoff process for the mortgage loan helps clients to refinance their loan. The original mortgage that had a floating interest rate is converted to a fixed interest rate mortgage and a one-price home mortgage lending system is achieved.

The forgoing implementation can be applied to refinancing a home mortgage, securing a loan for a new house buyer, and liquidating a preliminary loan.

According to Formula 1, if Mr. A offers $100 bid in the first term and the system via the analysis of the interest rate calculation module does not accept the offer, Mr. A can not obtain the loan fund. However, Mr. A then needs to provide only $2,900 (i.e. U−In) as a unit deposit at next repayment term to become a depositor and has a right to offer another bid. That is, Mr. A earns an interest of $100 form the system. As a result, Mr. A enjoys the advantages of the one-price mortgage lending system even his offer of $100 bid is not accepted.

According to Formula 2, if Mr. A offers $100 bid in the first term and the system via the analysis of the interest rate calculation module accepts the offer, Mr. A can obtain a loan fund of:

($3,000×(180−1))+($3,000×(1−1)+0=$537,000.

After Mr. A receives the winning bid for $537,000 to partially repay his loan, he must repay a repayment price of $3,100 (i.e. U+In) monthly with the system during the existing period (this case has 179 terms).

According to Formula 2, if Mr. A offers $100 bid in the first term and the system via the analysis of the interest rate calculation module does not accept the offer, Mr. A can not obtain the loan fund. However, Mr. A needs to provide only $3,000 (i.e. the unit price) as a unit deposit at next repayment term to become a depositor and has a right to offer another bid. That is, Mr. A earns an interest of $100 form the system. As a result, Mr. A enjoys the advantages of the one-price mortgage lending system even his offer of $100 bid is not accepted.

Implementation 2:

Mr. B just graduated from school and has a new job. In order to avoid excessive consumption and to better plan for the future, he decides to save money for buying a house. Since Mr. B just graduated and is not urgent for having a house, he is still not able to pay for the down payment. In addition, most banks only offer a low deposit interest rate which cannot satisfy him for a forced savings plan on a future housing demand. After he learned of the one-price mortgage lending system of the present invention, Mr. Be knew this project could help satisfy his savings and housing purchase plan. He then decides to submit an application to this financial institution system.

Mr. B applies to join the one-price mortgage lending system. He passes the system review and become a formal member. After he has completed his registration and an audit process for qualification, the system inquires whether Mr. B wants a mortgage loan. Since currently Mr. B has no ability to buy a house, he decides not to apply for a loan until he saves enough money for the down payment. According to Mr. B's self-analysis he decides to spend about $500,000 to buy a house. According to market practices he needs to make a down payment of at least 20 percent of a home's purchase price to get a home loan. Therefore, he can get ready to buy a house when his savings reach $100,000. After Mr. B decides to attend an auction combination with a 20-year term (i.e. 240 terms), submitting one bid for each month with the upper limit on the bidding price set at $2,000 (i.e. the scale of the auction combination is $2,000.times.240=$480,000), and obtains an auction certificate which identifies his ownership of the total deposits on the system and shows his privilege to attend the auction for mortgage lending on the system in the future.

Time passes and the down payment has accumulated $100,000 at the 50th term. (Here we ignore the basic bidding price provided by the system, even if the system provides it, there is not much difference with the actual deposit amount). Due to Mr. B reaching his necessary down payment he starts to search for a house. After a two months search, Mr. B decides to buy a house for $550,000. Since Mr. B doesn't have enough money to buy a $550,000 house, he applies for a mortgage loan on the system to cover the payment demand for the house. If the appraisal says the house is worth $600,000, according to the data provided to the financial institution responsible for operating the system, the lender may originate a mortgage loan with a loan-to-value ratio at 80%. Therefore, Mr. B was approved a loan of $480,000. If Mr. B agrees to accept the appraisal he accepts this $480,000 loan. However, there is still a shortage of $70,000 between the $480,000 loan and $550,000 house cost. The system via the member lending organization structure analysis gives another $70,000 credit loan to pay the seller. Mr. B may need to provide further collateral depending on his credit status to receive the credit loan.

This loan is basically similar to a conventional loan, and is amortized with a variable rate structure which cannot prevent exposure to interest rate risk. For this reason, Mr. B will then attend the auction to receive an affordable and fixed-payment mortgage loan. Assuming Mr. B offers a bid at $100 at the 54th term the system accepts the offer via the analysis of the interest-rate calculation module. According to the abovementioned formula 1, Mr. B can obtain

($2,000−$100).×.(240−54)+$2,000.×.(541−1)=$459,400

After Mr. B obtains the loan funds, similarly to the implementation 1, high priority is given to reimburse the $480,000 loan. Since the amount of the auction fund has an uncertainty, the funds obtained from the auction process cannot be used to reimburse the total loan amount. Thus, the loan still has $20,600 outstanding after the existing loan is paid off. Similarly, after Mr. B pays off his partial loan, he must repay a repayment price of $2,000 (i.e. the unit price) monthly during the remaining terms for future combinations. As a result, Mr. B enjoys the advantages of the one-price mortgage lending system.

Implement 3:

Mr. C is a middle level manager in a business firm and he owns a house that has had the mortgage paid off. Since the present house does not satisfy his family's needs, he contacts the system with the intention of accumulating funds for purchasing a house. He estimates his existing house value is $600,000. This plus $200,000 in personal savings, he will still need an additional $700,000 to buy a $1,500,000 house. After self-analysis, he decides to accept a mortgage loan with 240 terms and a $3,000 upper bidding limit. Until the 33rd term, his deposit fund is over $85,000. However, Mr. C receives a notice telling him his company is relocated him abroad. He must abandon his original plans for the house. Since the system will issue an auction certificate to non bid-winners (in virtual or real form), it discloses their future auction privileges and allows members to transfer the certificates or use the certificates for mortgages.

At this time Mr. C can, via the auction transaction mechanism provided by the system, make a transfer transaction for the auction certificate. Meanwhile, Mr. D via the auction transaction offers $92,000 to buy the auction certificate. If Mr. C sells his auction certificate, not only can he earn part of interest benefit of $7,000 ($92,000−$85,000), but he can smoothly exit the trading combination. And Mr. D, by obtaining the auction certificate directly attends a fund auction combination which has 207 terms of $3,000 each term, earns his interest income in order to deal with the demand of the housing fund.

An object of the one-price mortgage lending system is to provide members with direct on-line contact opportunities. This is different from other types of mortgages and means the financial institutions can charge a commission fee to the system clients as remuneration for using system services. The mortgage loan, which is provided by the system, is basically a form of financing. The core value of the existing system is the ability to provide funds with auction opportunities, and the commission fee is the main benefit source. This mechanism allows the financial institution to convert into a financial supplying service provider by implementing the spirit of direct finance.

In an embodiment of the present invention the system and members utilize a private network to interact. Since the server is on a private network the system has increased security.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An online one-price home mortgage lending system for providing a home loan to a user, the system comprising:
a member identification auditing module for storing the user's personal information in order to verify the user;
a house appraisal module for appraising a house value for a target house regarding to the user to generate an appraisal result;
a loan amount auditing module for retrieving the user's personal information and the appraisal result to determine an auction combination, wherein the auction combination comprise a loan amount, repayment terms for the loan amount, and a unit price for each repayment term, wherein the unit price is set forth by dividing the loan amount to the repayment terms;
an interest rate calculation module for calculating an interest rate for the loan amount to decide an acceptable bid price level; and
a home loan auction transaction module for receiving a bid price submitted by the user and deciding whether or not accepting the bid price according to the acceptable bid price level;
wherein if the user does not submit the bid price, the system requests the user to provide the unit price at every repayment term to become a depositor; if the user submits the bid price and the bid price is accepted, the system allows the user to obtain a loan fund and requests the user to repay an repayment price at every remaining repayment term; and if the bid price is not accepted, the system requests the user to provide a unit deposit to become the depositor, wherein at least one of the amount of the loan fund, the repayment price and the unit deposit is determined according to the bid price.

2. The online one-price home mortgage lending system of claim 1, wherein if the bid price is accepted, the system allows the user to obtain the loan fund according to the following formula:
An=(U−In)×((N−n))+(U×(n−1));
wherein An denotes the total amount of the loan fund; U denotes the unit price; N denotes the total repayment terms; n denotes the repayment term of receiving the bid price; and In denotes the bid price;
wherein if the bid price is accepted, the system allows the user to obtain the loan fund and requests the user to provide U as the repayment price at every remaining repayment term; and if the bid price is not accepted, the system requests the user to provide U−In as the unit deposit to become the depositor.

3. The online one-price home mortgage lending system of claim 1, wherein the system allows the user to obtain the loan fund according to the following formula:
$$An = ( U \times ( N - n ) ) + ( U \times ( n - 1 ) ) + {\sum }_{i = 1}^{n - 1} Ii ;$$
wherein An denotes the total amount of the loan fund; U denotes the unit price; N denotes the total repayment terms; n denotes the repayment term of receiving the bid price; and Ii denotes the bid price submitted by the user in the prior repayment term;
wherein if the bid price is accepted, the system allows the user to obtain the loan fund and requests the user to provide U+In as the repayment price at every remaining repayment term; and if the bid price is not accepted, the system requests the user to provide U as the unit deposit to become the depositor.

4. The online one-price home mortgage lending system of claim 1, wherein the system comprise:
a clearing and delivering module for clearing and delivering the users' payments for each unit price, each repayment price or each unit deposit; and
a home loan structure organization module for analyzing and comparing difference between the appraisal result and the loan amount.

5. The online one-price home mortgage lending system of claim 1, wherein the system comprise:
a home loan structure organization module for enabling the user to analyze the appraisal result and the loan amount in order to facilitate decision making.

6. The online one-price home mortgage lending system of claim 1, wherein the home loan auction transaction module sets forth a time period for receiving the bid price from the user.

7. The online one-price home mortgage lending system of claim 1, wherein if the bid price is not accepted, the home loan auction transaction module allows the user to continuously submit an escalating bid price.

8. The online one-price home mortgage lending system of claim 1, wherein the system comprises a home loan auction certificate module for issuing an auction certificate; if the bid price is not accepted, the home loan auction certificate module issues the home loan auction certificate to the user for allowing the user to submit another bid price at other repayment terms.

9. The online one-price home mortgage lending system of claim 8, wherein the home loan auction certificate is transferable by the home loan auction certificate module.

10. A method for an online one-price home mortgage lending system comprising:
providing a user interface to allow a user to interact with the system;
receiving a loan application from the user;
appraising a house value for a target house regarding to the user to generate an appraisal result;
determine an auction combination, wherein the auction combination comprise a loan amount, repayment terms for the loan amount, and a unit price for each repayment term, wherein the unit price is set forth by dividing the loan amount to the repayment terms;
calculating an interest rate for the loan amount to decide an acceptable bid price level; and
receiving a bid price submitted by the user and deciding whether or not accepting the bid price according to the acceptable bid price level; wherein if the bid price is accepted, announcing a message enabling the user to obtain a loan fund and to repay an repayment price at every remaining repayment term; if the bid price is not accepted, announcing another message pushing the user to provide a unit deposit to become a depositor, wherein at least one of the amount of the loan fund and the unit deposit is determined according to the bid price.

11. The online one-price home mortgage lending system of claim 10, comprising:
if the bid price is accepted, announcing the message enabling the user to obtain the loan fund according to the following formula:
An=(U−In)×((N−n))+(U×(n−1)),
wherein An denotes the total amount of the loan fund; U denotes the unit price; N denotes the total repayment terms; n denotes the repayment term of receiving the bid price; and In denotes the bid price; and pushing the user to provide U as the repayment price at every remaining repayment term; and
if the bid price is not accepted, announcing the another message pushing the user to provide U−In as the unit deposit to become the depositor.

12. The online one-price home mortgage lending system of claim 10, comprising:
if the bid price is accepted, announcing the messages enabling the user to obtains the loan fund according to the following formula:
$$An = ( U \times ( N - n ) ) + ( U \times ( n - 1 ) ) + {\sum }_{i = 1}^{n - 1} Ii ,$$
wherein An denotes the total amount of the loan fund; U denotes the unit price; N denotes the total repayment terms; n denotes the repayment term of receiving the bid price; and Ii denotes the bid price submitted by the user in the prior repayment term, and pushing the user to provide U+In as the repayment price at every remaining repayment term; and
if the bid price is not accepted, announcing the another message pushing the user to provide U as the unit deposit to become the depositor.

13. The method for an online one-price home mortgage lending system of claim 10, comprising:
clearing and delivering the users' payments for each unit price, each repayment price or each unite deposit; and
analyzing and comparing difference between the appraisal result and the loan amount.

14. The method for an online one-price home mortgage lending system of claim 10, comprising:
enabling the user to analyze the appraisal result and the loan amount in order to facilitate decision making.

15. The method for an online one-price home mortgage lending system of claim 10, comprising:
setting forth a time period for receiving the bid price from the user.

16. The method for an online one-price home mortgage lending system of claim 10, wherein if the bid price is not accepted, the method further comprising:
allowing the user to continuously submit an escalating bid price.

17. The method for an online one-price home mortgage lending system of claim 10, wherein if the bid price is not accepted, the method further comprising:
issuing a home loan auction certificate to the user for allowing the user to submit another bid price at other repayment terms.

18. The method for an online one-price home mortgage lending system of claim 17, comprising:
transferring the home loan auction certificate.
